(19) United States
(12) Patent Application Publication
(10) Pub. No.: US 2003/0201960 A1
(43) Pub. Date: Oct. 30, 2003

(54) Display device and driving method thereof

(75) Inventor: Ichiro Fujieda, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/424,925

(22) Filed: Apr. 29, 2003

(30) Foreign Application Priority Data
Apr. 30, 2002 (JP) 129411/2002

(51) Int. Cl. G09G 3/36

(52) U.S. Cl. 345/87

(57) ABSTRACT

The invention provides a thin type display device provided with a simplified constitution and driving circuit, which offers an excellent visibility both in a light place and in a dark place.

Liquid crystal 70 is placed between a substrate 10 on which a plurality of light emitting devices 20 including a reflecting electrode 21 is disposed and a transparent substrate 60 provided with a transparent electrode 63 and a color filter 61. A driving circuit switches to either a reflection display mode of displaying an image by reflection of ambient light from the reflecting electrode 21 of the light emitting device 20, or a self-emission display mode of displaying an image by self light emission from the light emitting device 20.

This application is based on Japanese patent application NO.2002-129411, the content of which is incorporated hereinto by reference.

### BACKGROUND OF THE INVENTION

1. Field of the Invention

The present invention relates to a thin type display device to be installed in a mobile phone, mobile information terminal, laptop computer, etc., more specifically to a thin type display device that displays an image by reflection of ambient light in a light place but by self-emission in a dark place.

2. Description of the Related Art

A reflection type liquid crystal display device has been conventionally known as a thin type display device that displays an image by reflection of ambient light. FIG. 11 is a schematic cross-sectional drawing showing a cross-section of a pixel portion of a reflection type liquid crystal display device that is specifically known as “single polarizing plate system”. This reflection type liquid crystal display device is constituted of a substrate 110 and a transparent substrate 120 with liquid crystal 130 placed therebetween. A plurality of reflecting electrodes 111 is disposed on a face of the substrate 110 that is confronting the transparent substrate 120, while color filters 121 are disposed on a face of the transparent substrate 120 that is confronting the substrate 110, at positions corresponding to the reflecting electrodes 111, and a transparent electrode 123 is uniformly formed so as to cover the color filters 121.

On the surfaces of the both substrates in contact with the liquid crystal 130, alignment layers 114 and 124 are respectively disposed, for predetermining an alignment direction of the liquid crystal. Also, a wiring 112 for independently controlling potential of each of the reflecting electrodes 111 is arranged among the reflecting electrodes 111 on the surface of the substrate 110. Also, the color filters 121 are constituted of three types of materials that respectively transmit red, green and blue rays at a high rate, and black matrix 122 made of a material that does not transmit any light is disposed in clearances between the three types of color filters 121. The black matrix 122 generally has a grid-patterned plane face. Further, a circular polarizing plate 140 having a function of exclusively transmitting a particular circular polarized light out of ambient incident light is disposed on a surface of the transparent substrate 120 that confronts a viewer. The circular polarizing plate 140 is usually constituted of a linear polarizing plate and a λ/4 wavelength plate layered with their light axis tilted by a certain angle from each other. Also, in the constitution shown in this drawing, a function of diffusing light is performed by a light diffusing material included in the color filter 121, and the reflecting electrodes 111 do not have a light diffusing function.

Now referring to FIG. 11, operation of a conventional reflection type liquid crystal display device shall be described. Ambient light is incident from an upper direction of the circular polarizing plate 140 and, for example, only one circularly-polarized light is transmitted through the circular polarizing plate 140. This circular polarized light passes through the transparent substrate 120 and then only light of a particular wavelength reaches the liquid crystal 130 because of the color filter 121. Here, an alignment status of the liquid crystal 130 is controlled by a potential of the reflecting electrode 111, in such a manner that, for example, designing parameters like liquid crystal material or liquid crystal layer thickness etc. are selected so that the polarization status is not changed while a voltage is not applied, and in case where a voltage is applied the circular polarized light is converted into a linear polarized light. Firstly, in case where a voltage is not applied to the reflecting electrode 111, the one circularly-polarized light of a particular wavelength incident on the liquid crystal 130 remains as it is and reaches the reflecting plate 111, and turns into the other circularly-polarized light at the time of reflecting. Polarization status is not changed when the light passes upward from a lower direction either, therefore the other circularly-polarized light passes through the color filter 121 and the transparent substrate 120 in turn to reach the circular polarizing plate 140. Since the other circularly-polarized light is absorbed by the circular polarizing plate 140, the light does not leak outside. Accordingly, this pixel displays black.

Secondly, in case where a voltage is applied to the reflecting electrode 111, the light that has passed through the liquid crystal 130 turns into linear polarized light, which the reflecting electrode 111 can reflect. The reflected linear polarized light turns into one circularly-polarized light upon passing through the liquid crystal 130, and therefore passes through the circular polarizing plate 140. Accordingly, this pixel displays a color determined by the color filter 121. Through such control of potential of each reflecting electrode 111, a desired color image can be displayed.

Meanwhile, an organic EL (Electro-Luminescence) display device in which an electro-luminescence effect of an organic material is utilized has conventionally been known as a thin type display device that displays an image by self-emission. FIG. 12 is a schematic cross-sectional drawing showing a cross-section of a constitution of a pixel portion in particular, in the organic EL display device. In the organic EL display device shown in FIG. 12, a plurality of light emitting devices 220 is formed on a surface of a substrate 210, over which a protection layer 240 and a color filter 250 are formed, over which further a protection substrate 260 and a circular polarizing plate 270 are layered. The light emitting device 220 is provided with a lower electrode 221 formed on the substrate 210, a light emitting layer 222 layered over the lower electrode 221 and an upper electrode 223 layered over the light emitting layer 222, in such a manner that the light emitting layer 222 is disposed between the lower electrode 221 and the upper electrode 223. Here, the lower electrode 221 and the upper electrode 223 are formed of a light reflecting material and a light transmitting material respectively, so that light can pass through the upper electrode 223 to be emitted toward outside. In this conventional art, a material for constituting the light emitting device is to be selected so that white light emission is performed when power is supplied to the light emitting device. On the surface of the substrate 210, a wiring 230 is arranged among the light emitting devices 220 for controlling whether to supply power or not to each light emitting device 220.

Now referring to FIG. 12, operation of the conventional organic EL display device shall be described. When power is supplied to the light emitting device 220 controlling a voltage to be applied to the wiring 230, white light is emitted, out of which a ray of a particular wavelength passes through the color filter 250, and then through the transparent substrate 260 and the circular polarizing plate 270 in turn, and leaks toward outside. By thus controlling light emitting amount of each individual light emitting devices 220, a desired color image can be displayed. Here, in case where ambient light is incident, it turns into for instance light circular polarized light because of the circular polarizing plate 270. This one circularly-polarized light turns into other circularly-polarized light upon reflecting from the lower electrode 221 of the light emitting device 220, and is absorbed while passing upward from a lower direction through the circular polarized plate 270. Consequently, deterioration of contrast of an image displayed with the light emitted by the light emitting device 220 due to ambient light can be restricted.

However, since a reflection type liquid crystal display device displays an image by reflection of ambient light, it has a problem that image quality significantly deteriorates in a dark place. An auxiliary light source has been proposed for resolving this problem, however addition of an auxiliary light source spoils a great advantage of the device of being thin. Further, in case where a front light is used as an auxiliary light source, image quality deteriorates in its normal use in which ambient light is utilized. Accordingly, a conventional reflection type liquid crystal display device has the disadvantage of deterioration of image quality when used in a dark place.

On the other hand, since an organic EL display device emits light itself, a clear display can be performed in a dark place. However in a light place contrast of a displayed image deteriorates because of reflection of ambient light. Increasing its light emitting capacity could be a measure for this problem, but it would result in deterioration of a life span of the light emitting device and increase of power consumption, therefore actually there is no other choice but to reluctantly accept an unsatisfactory image quality. Accordingly, a conventional organic EL display device has the disadvantage of deterioration of displayed image contrast in a light place.

Because of such characteristics, visibility just in one situation, whether a light place or a dark place, has to be focused with priority depending on operating principle of the display device. In other words, by a conventional thin type display device it is impossible to achieve a satisfactory visibility in both of a light place and a dark place.

With an object to solve this problem, a display device wherein an organic electro-luminescence display device 1 and a liquid crystal display device 2 are layered in this sequence from a viewer's side has been proposed (JP-A No. 2001-92390) Also, a display device has been disclosed with an object to provide a display device having a backlight capable of displaying a design pattern such as a cartoon character, in addition to surface emitting function for a transmission type display device, wherein an organic EL panel is disposed at the back of a liquid crystal display panel and an electrode is formed on the organic EL device so that a pattern can be displayed (JP-A No.11-160704).

However, display devices according to these prior arts have a constitution in which an EL display device or EL backlight and a liquid crystal display device, which are separately manufactured, are simply layered. Therefore, still there is a problem that a transparent substrate is formed between the EL display device or EL backlight and the liquid crystal display unit, and that both of them respectively require an appropriate diving circuit.

The invention has been made in view of the foregoing problems, with an object to provide a thin type display device that offers an excellent visibility both in a light place and in a dark place, with an additional advantage of a simplified constitution and driving circuit.

### SUMMARY OF THE INVENTION

A display device according to the first invention comprises a first substrate on which a plurality of light emitting devices including a reflecting electrode is disposed; a second substrate made of a transparent material provided with a color filter and a transparent electrode; a liquid crystal layer placed between the first substrate and the second substrate disposed in such a manner that a face with the light emitting devices and a face with the transparent electrode confront each other; and a driving circuit for controlling a voltage to be applied to the liquid crystal layer, and selecting either a reflection display mode of displaying an image by reflecting ambient light with the reflecting electrode of the light emitting device or a self-emission display mode of displaying an image by light emission of the light emitting device.

A display device according to the second invention comprises a first substrate on which a plurality of light emitting devices including a reflecting electrode is disposed and a color filter is provided over them; a second substrate made of a transparent material provided with a transparent electrode; a liquid crystal layer provided between the first substrate and the second substrate disposed in such a manner that a face with the color filter and a face with the transparent electrode confront each other; and a driving circuit for controlling a voltage to be applied to the liquid crystal layer, and selecting either a reflection display mode of displaying an image by reflecting ambient light with the reflecting electrode of the light emitting device or a self-emission display mode of displaying an image by light emission of the light emitting device.

In these display devices, the light emitting device may, for example, further comprise a light emitting material formed on the reflecting electrode and a transparent electrode formed on the light emitting material.

Also, the driving circuit may, for example, further control optical characteristic of the liquid crystal through control of a voltage applied between the transparent electrode of the light emitting device and the transparent electrode of the second substrate, and control light emission by the light emitting device through control of a voltage applied between the transparent electrode of the light emitting device and the reflecting electrode.

Also, in these display devices, for example, each of the light emitting devices and the color filter corresponding to each light emitting device may constitute a pixel, and the driving circuit may comprise a switching transistor for selecting each of such pixels, light emission amount control circuit for controlling a current amount of the light emitting device and a switching control circuit for switching to either of the reflection display mode or the self-emission display mode.

Further, the switching control circuit may, for example, electrically connect the reflecting electrode of the light emitting device with the transparent electrode of light emitting device as well as the switching transistor with the reflecting electrode of the light emitting device, in the reflection display mode.

Further, the switching control circuit may, for example, connect the light emitting device with the light emission amount control circuit as well as the switching transistor with the light emission amount control circuit, in the self-emission display mode.

Also, these display devices may, for example, further comprise a circular polarizing plate on a surface of the second substrate on a face not confronting the liquid crystal layer, so that the driving circuit adjusts a reflection factor of ambient light by switching a polarization status of light passing through the liquid crystal layer, in the reflection display mode.

Also, these display devices may, for example, further comprise a circular polarizing plate on a surface of the second substrate on a face not confronting the liquid crystal layer, so that the driving circuit maintains a constant polarization status of light passing through the liquid crystal layer, in the self-emission display mode.

The first substrate may, for example, comprise a protection layer covering the light emitting device and a first alignment layer formed on the protection layer, and the second substrate may comprise a second alignment layer formed on the transparent electrode. In this case, the protection layer may be provided with a projection or a strut that reaches the second substrate, between the first substrate and the second substrate and in a region where the light emitting devices are not located.

The first substrate may, for example, comprise a protection layer formed between the color filter and the light emitting device so as to cover the light emitting device and a first alignment layer formed on the color filter, and the second substrate may comprise a second alignment layer formed on the transparent electrode.

The third invention provides driving method of a display device comprising a first substrate on which a plurality of light emitting devices including a reflecting electrode is disposed; a second substrate made of a transparent material provided with a color filter and a transparent electrode; a liquid crystal layer provided between the first substrate and the second substrate disposed in such a manner that a face with the light emitting devices and a face with the transparent electrode confront each other; comprising the steps of controlling a voltage to be applied to the liquid crystal layer, and selecting either a reflection display mode of displaying an image by reflecting ambient light with the reflecting electrode of the light emitting device or a self-emission display mode of displaying an image by light emission of the light emitting device.

The fourth invention provides driving method of a display device comprising a first substrate on which a plurality of light emitting devices including a reflecting electrode is disposed and a color filter is provided over them; a second substrate made of a transparent material provided with a transparent electrode; a liquid crystal layer provided between the first substrate and the second substrate disposed in such a manner that a face with the color filter and a face with the transparent electrode confront each other; comprising the steps of controlling a voltage to be applied to the liquid crystal layer, and selecting either a reflection display mode of displaying an image by reflecting ambient light with the reflecting electrode of the light emitting device or a self-emission display mode of displaying an image by light emission of the light emitting device.

In the foregoing method, the reflecting electrode and the transparent electrode of the light emitting device formed with the light emitting material disposed therebetween may be electrically connected in the reflection display mode.

Also, in the self-emission display mode, a light emission amount control circuit for controlling a light emission amount of the light emitting device may be connected with the light emitting device.

### BRIEF DESCRIPTION OF THE DRAWINGS

FIG. 1 is a schematic cross-sectional drawing showing principal factors of a display device according to the first embodiment of the present invention;

FIG. 2 is a circuit diagram showing a circuit configuration of a pixel according to the first embodiment of the invention;

FIG. 3 is a timing chart for explaining an operation in a reflection display mode in the first embodiment of the invention;

FIG. 4 is a circuit diagram for explaining a circuit configuration in the reflection display mode in the first embodiment of the invention;

FIG. 5 is a schematic cross-sectional drawing for explaining an operation in the reflection display mode in the first embodiment of the invention;

FIG. 6 is a timing chart for explaining an operation in a self-emission display mode in the first embodiment of the invention;

FIG. 7 is a circuit diagram for explaining a circuit configuration in the self-emission display mode in the first embodiment of the invention;

FIG. 8 is a schematic cross-sectional drawing for explaining an operation in the self-emission display mode in the first embodiment of the invention;

FIG. 9 is a schematic cross-sectional drawing showing principal factors of a display device according to the second embodiment of the invention;

FIG. 10 is a schematic cross-sectional drawing showing principal factors of a display device according to the third embodiment of the invention;

FIG. 11 is a schematic cross-sectional drawing showing principal factors of a conventional reflection type display device; and

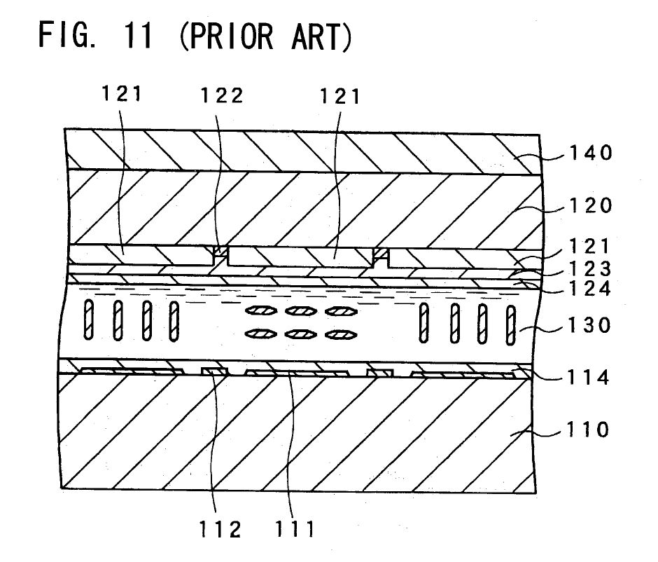

FIG. 12 is a schematic cross-sectional drawing showing principal factors of a conventional self-emission type display device.

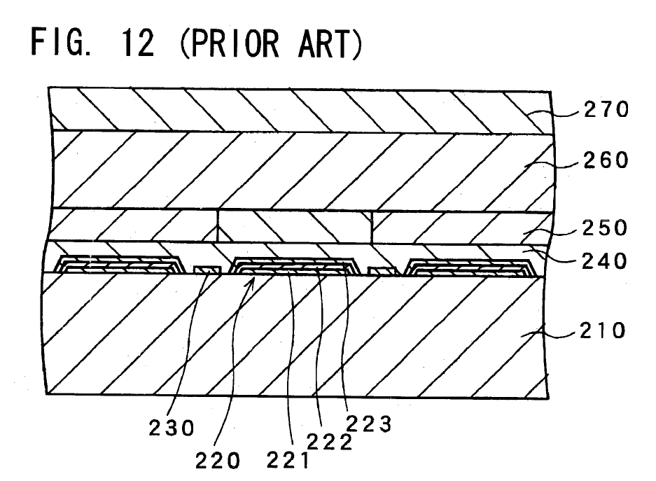

### DESCRIPTION OF THE PREFERRED EMBODIMENT

Referring to the accompanying drawings, embodiments of the present invention shall be described hereunder.

First Embodiment

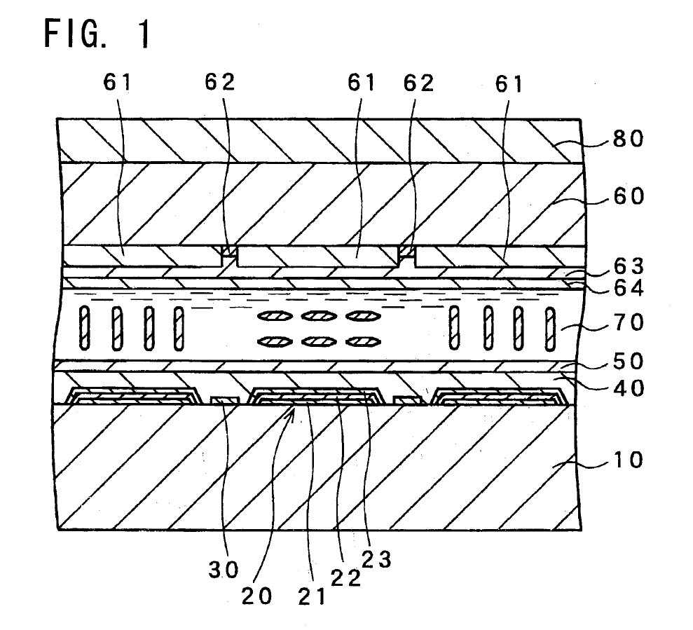

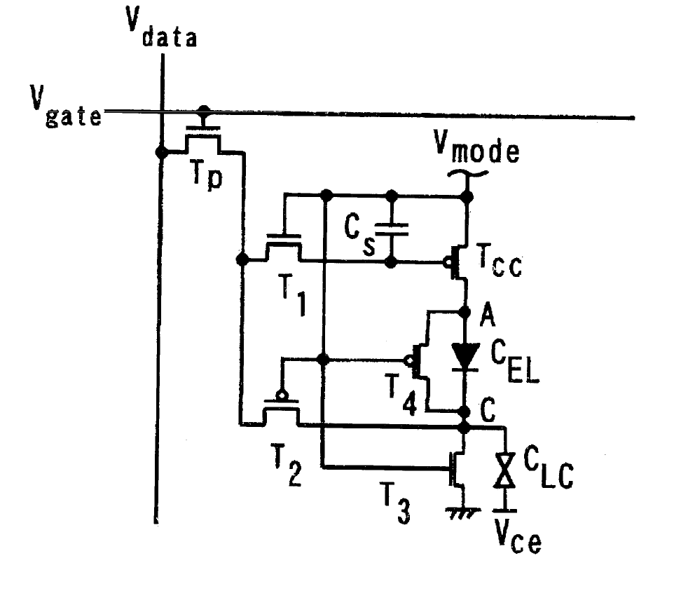

FIG. 1 is a schematic cross-sectional drawing showing a display device according to the first embodiment of the invention. Here, FIG. 1 shows a constitution of a cross-section of a pixel portion of the display device. Also, FIG. 2 is a circuit diagram showing a circuit configuration per pixel in the pixel portion. As shown in FIG. 1, in this display device a substrate (a first substrate) 10 on a surface of which a plurality of light emitting devices 20 is disposed, and a transparent substrate (a second substrate) 60 on which color filters 61 are disposed at positions corresponding to the light emitting devices 20 and a transparent electrode 63 is uniformly formed over them, are confronting each other with liquid crystal 70 placed therebetween.

The light emitting device 20 is provided with a lower electrode 21 formed on the substrate 10, a light emitting layer 22 formed on the lower electrode 21 and a transparent upper electrode 23 formed on the light emitting layer 22, in such a manner that the light emitting layer 22 is disposed between the lower electrode 21 and the upper electrode 23. The lower electrode 21 and the upper electrode 23 are made of a light reflecting material and a light transmitting material respectively. Therefore, light passes through the upper electrode 23 and is emitted toward outside. Also, a material for constituting the light emitting device is to be selected so that white light is emitted when power is supplied to the light emitting device 20.

Also, a wiring 30 for electrically controlling the light emitting device and the liquid crystal 70 is arranged among each light emitting device 20 on the surface of the substrate 10. Further, the substrate 10 is provided with various circuit factors on its surface in addition to the light emitting devices 20 though they are not shown in FIG. 1, and the light emitting devices 20 and various circuit factors are connected mutually or with an exterior circuit through the wiring 30 arranged among the light emitting devices 20, etc. Specific details of such circuit factors shall be subsequently described referring to FIG. 2. A protection layer 40 is formed over the light emitting device 20. Also, on the face that is in contact with the liquid crystal 70, an alignment layer 50 for predetermining an alignment direction of the liquid crystal is provided.

Meanwhile referring to the transparent substrate 60, on a face that is confronting the substrate 10 a transparent electrode 63 is formed so as to cover the color filter 61, and on a face of the transparent electrode 63 in contact with the liquid crystal 70 an alignment layer 64 for predetermining an alignment direction of the liquid crystal is provided. With respect to the alignment of the liquid crystal, materials of the liquid crystal 70 and the alignment layers 50 and 64 are to be selected so that the liquid crystal molecules are horizontally aligned (homogeneous alignment) along the substrate.

Also, the color filter 61 comprises three types of materials that respectively transmit red, green and blue rays at a high rate, and black matrix 62 made of a material that does not transmit any light is disposed in clearances between the three types of color filters 121 forming a grid pattern in a plan view. Further, in this embodiment a function of diffusing light is performed by a light diffusing material included in the color filter 61.

Further, a circular polarizing plate 80 having a function of exclusively transmitting a particular circular polarized light out of ambient incident light is disposed on a surface of the transparent substrate 60 that confronts a viewer. The circular polarizing plate 80 is usually constituted of a linear polarizing plate and a λ/4 wavelength plate layered with their light axis tilted by a certain angle from each other.

Now referring to FIG. 2, circuit factors of the pixel portion of this embodiment shall be described. As shown in FIG. 2, principal factors of the pixel portion of this display device include a transistor Tₚ serving as a switch for selecting a particular pixel, a light emitting device C_{EL}, a circuit for controlling a current amount on the light emitting device (transistor T_{cc}, capacitor Cₛ), liquid crystal C_{LC}, and transistors T1, T2, T3 and T4 serving as a control circuit for switching to either a reflection mode or a self-emission mode. These factors are controlled by control signals V_{gate}, V_{data}, V_{mode} and V_{ce} provided to three wirings.

Specifically, the control signal V_{gate} is input to a gate of the switching transistor Tₚ, and the control signal V_{data} is input to its source. The transistor T_{cc}, light emitting device C_{EL} and transistor T3 are connected in series between the control signal V_{mode} and a ground potential, and the capacitor Cₛ is connected between a source and gate of the transistor T_{cc}, and then the transistor T1 is connected between the transistor Tₚ and the gate of the transistor T_{cc}. To the gate of the transistor T1, the control signal V_{mode} is input. The transistor T4 is connected in parallel with the light emitting device C_{EL}, and the transistor T2 is connected between a cathode of the light emitting device C_{EL} and the transistor Tₚ. To the gate of the transistor T2, gate of the transistor T4 and gate of the transistor T3, the control signal V_{mode} is to be input. Also, between the cathode of the light emitting device C_{EL} and the control signal V_{ce} the liquid crystal C_{LC} is connected.

Also, referring to the cross-sectional drawing of FIG. 1 and the circuit diagram of FIG. 2, correspondence of the respective factors is as follows; the light emitting device 20 (C_{EL}) is a two-terminal device connected to outside through the reflecting lower electrode 21 and the transparent upper electrode 23. The light emitting device 20 is fed and turned on when a potential of the transparent upper electrode 23 is set higher than the reflecting lower electrode 21. In this occasion the reflecting lower electrode 21 and the transparent upper electrode 23 serve as a cathode and anode respectively. Further, in FIG. 2, the cathode and anode of the light emitting device 20 are respectively shown by codes C (Cathode) and A (Anode).

The liquid crystal 70 is a two-terminal device controlled by a potential given to the transparent electrode 63 and the transparent upper electrode 23 of the light emitting device 20, and is denoted as C_{LC} in FIG. 2.

A constitution of the transistors (Tₚ, T1, T2, etc.) in FIG. 2, which is not shown in FIG. 1 since the drawing would be too much complicated, is similar to those popularly adopted in a conventional display device, for example an MOS transistor in which poly-silicon is used as channel material. The transistors in FIG. 2 include n-type transistors turned conductive by a positive voltage and p-type transistors turned conductive by a negative voltage, depending on a polarity of a voltage applied to a gate electrode. According to the normal usage in the field, the p-type transistor is distinguished with a circle marked on its gate electrode in the circuit diagram, therefore the transistors T_{cc}, T2 and T4 are of p-type, while the transistors Tₚ, T1 and T3 are of n-type.

Further, the capacitor Cₛ in FIG. 2 is also constituted of a metal thin film and an insulating film that are required for forming a MOS transistor, though not shown in the drawing. Such formation of the capacitor is also popularly utilized in a conventional display device.

Some specific materials and numerical values are given below. It is desirable that the protection layer 40 has a thickness of not less than approx. 1 μm in order to secure a sufficient protecting effect. Silicon oxide nitride (SiON) or various organic materials are used as protection layer 40, and a refraction factor of these materials is in a range of approx. 1.4 to 1.7. Refraction factor of the liquid crystal 70 varies depending on whether ordinary light or extraordinary light, and it is desirable to adopt a liquid crystal that has a higher refraction factor against ordinary light than the protection layer. Preferable thickness of the liquid crystal layer is in a range of approx. 2 to 6 μm. For example, refraction factors of a liquid crystal BDH-TL213 manufactured by Merck Japan, Ltd. against ordinary light and extraordinary light is 1.52 and 1.76 respectively. The alignment layer may be formed of a polyimide family material in a thickness of approx. 100 nm, and through a rubbing process thereon the liquid crystal can be horizontally aligned. Also, an indium tin oxide (ITO) may be used as a material for the transparent upper electrode 23, transparent electrode 50 and transparent electrode 64, and its refraction factor is approx. 1.8 to 1.9. Thickness of these layers is preferably approx. 100 nm, which is thinner than a light wavelength. The light emitting layer 22 may be formed of a material popularly used in an organic EL display having a function of emitting light by electro-luminescence effect. An example of such materials is Alq (aluminum quinolinolato complex) etc. In FIG. 1 the light emitting layer 22 is illustrated as a single layer, while actually materials capable of transporting a hole are generally laminated to form a multiplayer structure. Materials for hole transporting layers include triarylamine derivatives, oxadiazole derivatives, etc. For the reflecting lower electrode 21, aluminum-lithium alloy etc. may be used.

Manufacturing method of the display device shown in FIG. 1 comprises a first step of forming the MOS transistors (not shown), light emitting device 20, protection layer 40, etc. on the substrate 10; a second step of forming the color filter 61, black matrix 62 and transparent electrode 63 on the transparent substrate 60; a third step of combining the both substrates with a clearance between each other and injecting the liquid crystal into the clearance; and a fourth step of attaching the circular polarizing plate 80 on the substrate 60 and connecting the wiring of the transistor circuit with an exterior circuit. The third step also includes forming the alignment layers 50 and 64 on the respective substrates and executing alignment of the liquid crystal. Also, each of these steps may be identical to currently adopted process for manufacturing an ordinary liquid crystal display device and organic EL display.

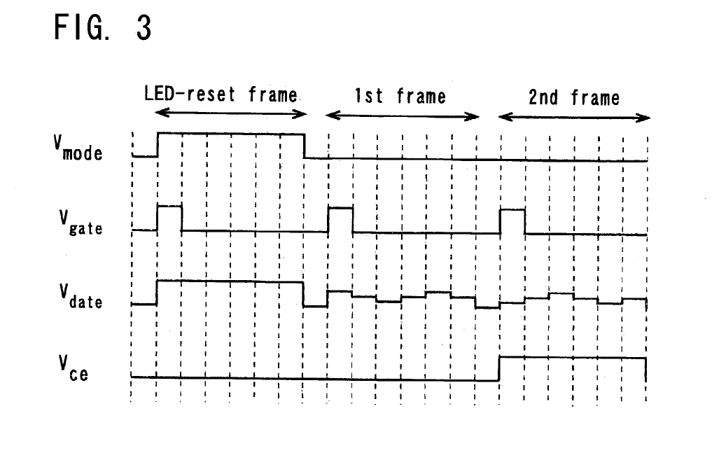

Now, operation of the display device of this embodiment shall be described. Firstly, operation in the reflection mode of this display device shall be described referring to FIGS. 3 to 5. FIG. 3 is a timing chart showing method of providing the control signals of FIG. 2 during displaying operation in the reflection mode. Also, a minimum necessary time for displaying an image is hereinafter referred to as a frame.

In a frame denoted as “LED-reset frame” in FIG. 3, the control signal V_{mode} is set at a level H to turn T1 conductive, then the V_{gate} is set at the level H to turn Tₚ conductive, and a voltage of the V_{data} at this moment is written in the Cₛ. Since the V_{data} is at the level H at this stage, the level H is written in the capacitor Cₛ and the transistor T_{cc} becomes non-conductive. In this way the level H is written in the capacitors Cₛ of all the pixels disposed in a matrix form, so that all the T_{cc} become non-conductive. In other words, at an ending moment of the frame all the light emitting devices 20 are turned off. Also, this frame is provided with an object to execute just once when the self-emission mode is switched to the reflection mode, so that all the light emitting devices 20 are turned off.

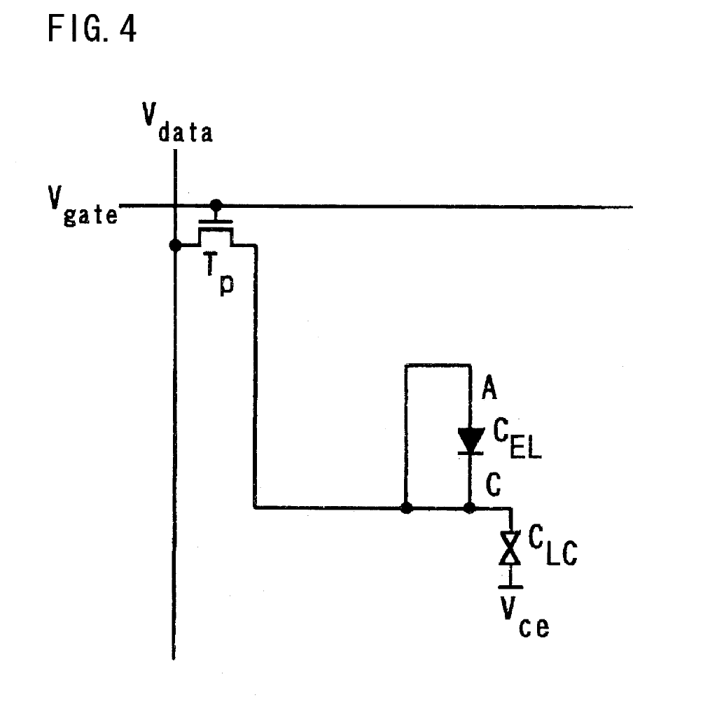

Then V_{mode} is set at a level L in subsequent frames after the frame, denoted as “1st frame” and “2nd frame” in FIG. 3, to turn T1 and T3 non-conductive and T2 and T4 conductive. A circuit at this moment is equivalent to FIG. 4, which is substantially the same circuit as a pixel generally used for a liquid crystal display device. Here, since the anode and the cathode of the light emitting device C_{EL} are short-circuited, it is equivalent to being disconnected. Therefore, by providing to V_{data} an image signal of an inverse polarity for each frame sequentially selecting V_{gate} and synchronically inverting a potential V_{ce} of the confronting transparent electrode (transparent electrode 63 of FIG. 1), displaying operation by frame inversion equivalent to that of an ordinary liquid crystal display device can be performed.

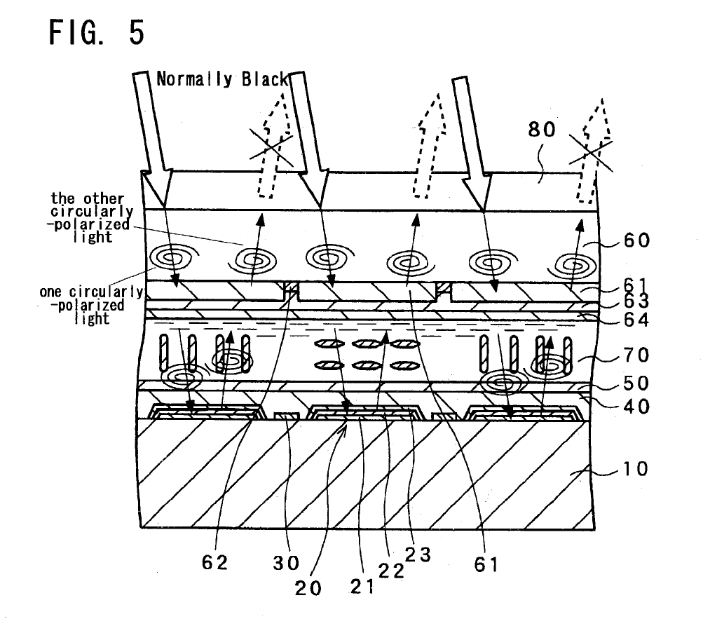

FIG. 5 is an explanatory drawing schematically showing an alignment of liquid crystal molecules and light course in a displaying operation in the reflection mode. As in a conventional reflection type liquid crystal display device, a reflecting state and non-reflecting type can be switched over by applying a voltage to the liquid crystal so as to control a polarizing status of light passing through the liquid crystal. Details of such operation are described hereunder.

Referring to FIG. 5, when ambient light is incident from an upper direction of the circular polarizing plate 80, for example one circularly-polarized light alone is transmitted through the circular polarizing plate 80. This one circularly-polarized light passes through the transparent substrate 60, and then only light of a particular wavelength reaches the liquid crystal 70 through the transparent electrode 63 and alignment layer 64 in turn, because of the color filter 61. Here, as schematically shown in FIG. 5, an alignment status of the liquid crystal 70 is controlled by a potential of the transparent upper electrode 23. As already mentioned, the transparent upper electrode 23 is short-circuited to the reflecting lower electrode 21 through the transistor T4. As such, since the transistor T2 is also conductive, the reflecting lower electrode 21 is connected with V_{data} through Tₚ. Therefore, an alignment status of the liquid crystal 70 is controlled by a potential set at V_{data}.

In this case, designing parameters like liquid crystal material or liquid crystal layer thickness etc. are to be selected so that, for example, the polarization status is not changed while a voltage is not applied, and in case where a voltage is applied the circular polarized light is converted into a linear polarized light.

Firstly, in case where a voltage is not applied to the transparent upper electrode 23, the one circularly-polarized light of a particular wavelength incident on the liquid crystal 70 remains as it is and passes through the alignment layer 50, protection layer 40, transparent upper electrode 23 and light emitting layer 22 in turn to reach the reflecting lower electrode 21. This one circularly-polarized light turns into other circularly-polarized light upon reflecting from the reflecting lower electrode 21, and passes through the mentioned factors in a reverse sequence to reach the liquid crystal 70. Polarization status is not changed when the light passes upward from a lower direction either, therefore the other circularly-polarized light passes through the alignment layer 64, transparent electrode 63, color filter 61 and the transparent substrate 60 in turn to finally reach the circular polarizing plate 80. Since the other circularly-polarized light is absorbed by the circular polarizing plate 80, the light does not leak outside. Accordingly, this pixel displays black.

Secondly, in case where a voltage is applied also to the reflecting lower electrode 21, the same potential is applied to the transparent upper electrode 23. Because of an alignment status of the liquid crystal, the light that has passed through the liquid crystal 70 turns into linear polarized light, and this linear polarized light reaches the reflecting lower electrode 21. The linear polarized light that has reflected from the reflecting lower electrode 21 turns into one circularly-polarized light upon passing through the liquid crystal 70, and passes through the circular polarizing plate 80. Accordingly, this pixel displays a color determined by the color filter 61. Through such control of potential of each reflecting lower electrode 21, a desired color image can be displayed.

What is unique in the foregoing constitution and operation is that the transparent upper electrode 23 of the light emitting device 20 is given a function as an electrode for applying a voltage to the liquid crystal, and that the reflecting lower electrode 21 of the light emitting device 20 is serving as a reflecting plate of the light.

Further, the black matrix 62 can reduce an amount of incident light into the color filter of an adjacent pixel, originating from the light that has reflected from one of the reflecting lower electrodes. Therefore, deterioration of image quality due to mixing of colors can be prevented.

Also, the color filter 61 includes a light diffusing material. The purpose is to prevent an ambient image from being displayed (invasion of an ambient image) caused by direct reflection of ambient incident light because of specular reflection by the reflecting lower electrode 21. Forming an uneven profiles distributed in various slope angles on the reflecting plate, as generally adopted in a conventional reflection type liquid crystal display device, can prevent such invasion of an ambient image. However, a height of the uneven profiles formed on the reflecting plate is approx. 1 μm while a thickness of the light emitting layer 22 is approx. 100 nm, therefore the reflecting lower electrode and the transparent upper electrode are prone to cause a short circuit. Consequently, it is preferable to utilize a light diffusing material, though it depends on a material for forming the light emitting layer. Location to provide the light diffusing material is not limited to the color filter 61, but may be provided in the protection layer 40.

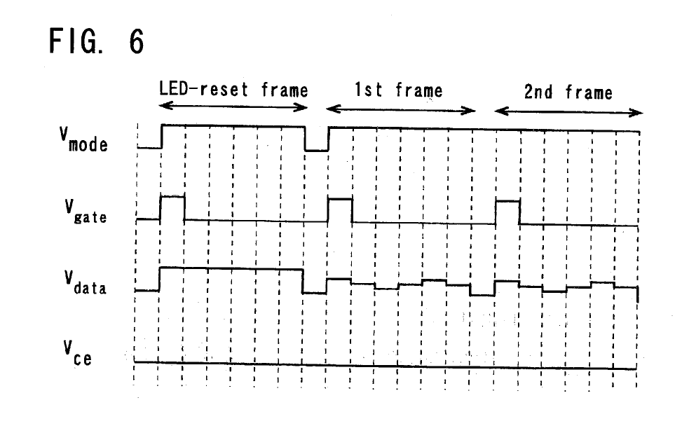

Now, operation of the display device in the self-emission mode according to this embodiment shall be described, referring to FIGS. 6 to 8. FIG. 6 is a timing chart showing method of providing the control signals of FIG. 2 during displaying operation in the self-emission mode.

A first frame (a portion denoted as “LED-reset frame” in FIG. 6) is for writing the level H in Cₛ of all the pixels to turn off the light emitting device as in the reflection mode. This frame does not necessarily have to be inserted.

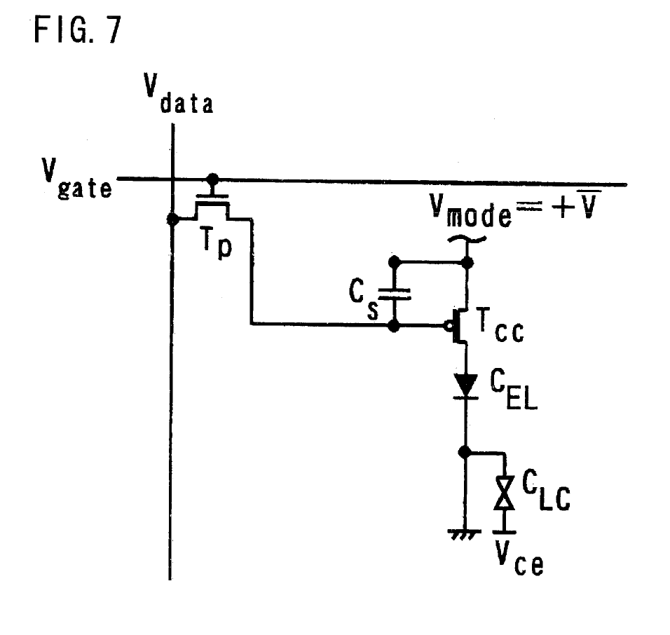

In subsequent frames, the control signal V_{mode} is set at a level H, to turn T1 and T3 conductive and T2 and T4 nonconductive. A circuit at this moment is equivalent to FIG. 7. Referring to FIG. 7, a terminal of the liquid crystal C_{LC} is connected with the cathode of the light emitting device C_{EL}, however since a potential of the other terminal V_{ce} is set at a level L, a voltage is not applied to the liquid crystal. Accordingly, an alignment of the liquid crystal is fixed in the self-emission mode so that a polarization status of light passing therethrough is not changed. Further, as shown in FIG. 6 V_{gate} is set at the level H so as to turn Tₚ conductive, and a voltage of V_{data} at this moment is written in Cₛ. At this stage a desired image signal is provided to V_{data}.

Firstly, in case where a potential written in Cₛ is of the level H, the light emitting device is turned off. This is the same as in the first frame. Accordingly, a pixel in which the level H is written displays black.

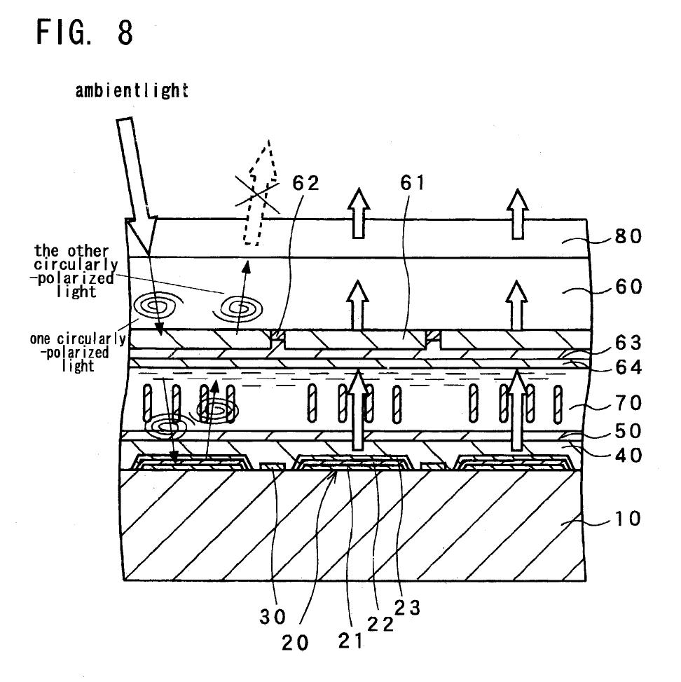

Meanwhile, in case where a potential of a certain value is written in Cₛ, conductivity of T_{cc} in FIG. 7 is changed, and a current according to such change flows on C_{EL}. In other words, referring to FIG. 8 light is emitted upward through the transparent upper electrode 23 from the light emitting layer 22 of the light emitting device 20. This light passes sequentially through the protection layer 40, alignment layer 50, liquid crystal 70, alignment layer 64 and transparent electrode 63, and then light of a particular wavelength alone is transmitted through the color filter 61. During this stage a polarization status of the light is not changed. Out of the light that has passed through the transparent substrate 60, a portion passes through the circular polarizing plate 80 and is emitted toward outside, and another portion is absorbed by the circular polarizing plate 80. Consequently, this pixel displays a color of the wavelength determined by the color filter 61, and an intensity of the light is set by a potential written in Cₛ.

According to the foregoing description, a desired color image can be displayed by respectively writing a potential corresponding to the desired image signal in Cₛ of all the pixels.

Now, since the light emitted by the light emitting layer 22 is isotropic, such light emitting device 20 by itself has a broad directionality. However, direction of emitted light may be restricted to a certain angle range depending on a refraction factor of materials used for the protection layer 40, alignment layer 50, liquid crystal 70, etc., by which a light emitting efficiency may be lowered resulting in a reduced luminance of the display device. It takes place because, when light emitted in a broad angle range is incident to a substance of a lower refraction factor from a substance of a higher refraction factor, a portion of light emitted in a broader angle than a critical angle determined by the two refraction factors is detained in the substance of a higher refraction factor. From the viewpoint of preventing such phenomenon, selection of materials for the protection layer 40 and liquid crystal 70, which have a thickness of not less than approx. 1 μm, is particularly important. A maximum refraction factor applied to the light passing through the liquid crystal is the refraction factor of the liquid crystal against extraordinary light, and the value, for example, of the liquid crystal BDH-TL213 manufactured by Merck Japan, Ltd. is 1.76. Therefore, by using a material having a refraction factor of approx. 1.5 to 1.7 (for instance, SiON) for the protection layer 40, the light can be prevented from being detained in the protection layer 40.

Also, even in case where ambient light is incident from an upper direction of the circular polarizing plate 80, contrast is not deteriorated by reflection of the ambient light. It is because, as described with respect to the displaying operation in the reflection mode, a “normally black” display is adopted that displays black when a voltage is not applied to the liquid crystal.

Variations of the First Embodiment

Now a variation of the foregoing embodiment shall be described. Firstly, alignment method of the liquid crystal shall be focused on. A function required from the liquid crystal layer constituted according to the invention is to control whether to reflect ambient light or not, by switching whether to change a polarizing status of light being transmitted or not. Therefore, as long as the liquid crystal can accomplish such function, different liquid crystal alignment method from the horizontal alignment employed in the foregoing embodiment can be adopted. For example, a hybrid alignment (wherein the liquid crystal molecules are vertically aligned on one substrate side and horizontally aligned on the other substrate side) may be adopted. Such alignment methods of the liquid crystal are popularly used as an ECB (Electrically Controlled Birefringence) mode in a conventional liquid crystal display device.

Secondly, a guest host (GH) mode liquid crystal may be adopted, which is also generally known in a conventional reflection type liquid crystal display device, instead of the ECB mode. The GH mode is based on a principle of mixing several percent of bicolor coloring matter molecules (guest) in the liquid crystal (host), and adjusting an extent of optical absorption by controlling an alignment of the bicolor coloring matter molecules with an alignment of the liquid crystal molecules. The GH mode has various constitutions, among which in a phase transition type, polymer-dispersed liquid crystal (PDLC) type, etc. especially, the reflecting electrode disposed on the substrate surface is in contact with the liquid crystal. Accordingly, by forming the light emitting device shown in FIGS. 1 and 2 at a lower position of the reflecting electrode a similar effect to that of the embodiment with the ECB mode can be achieved. Also, since these constitutions do not require a polarizing plate, a brighter display can be realized in the reflection mode. On the other hand, the PDLC type GH mode has the disadvantage of high driving voltage, and in the phase transition type GH mode coloring control is difficult.

Thirdly, the normally black mode wherein black is displayed when a voltage is not applied is adopted in the foregoing embodiments, while a normally white mode may be adopted wherein black is displayed when a voltage is applied, as is popular in a conventional reflection type liquid crystal display device.

Fourthly, the light emitting device of the invention is not limited to one that emits white light. Specifically, for example, light emitting devices that emit red, green and blue light may be disposed so as to confront a color filter that transmits the respective emitted wavelengths. Such constitution has the disadvantage of an increase of production cost since three types of light emitting devices are required, but on the other hand it has the advantage that a brighter display is achieved in the self-emission mode because less light is absorbed by the color filter.

As described above, it is possible for those of ordinary skill in the art to select different liquid crystal modes and control system of the liquid crystal, as well as to replace various constitutional factors without departing from the spirit of the invention. Therefore, it is to be understood that such variations are within the scope of the invention.

Second Embodiment

In case where a displaying area of a display device is considerably large, it is difficult to maintain a constant thickness of the liquid crystal layer. The reason is as follows. Normally, objects (spacers) for defining a thickness of the liquid crystal layer are mixed in a sealing material of the liquid crystal and disposed along a perimeter of the displaying area, so that the liquid crystal layer thickness is maintained at a constant level. Accordingly, in case that the displaying area becomes larger, it becomes difficult to control the liquid crystal layer thickness at a portion distant from the objects sealed in the liquid crystal (i.e. a central portion of the displaying area).

This problem has been well known in a conventional liquid crystal display device and, as a solution, in general similar spacers are dispersed over the liquid crystal layer. Otherwise, such method is also known that columns are provided instead of spacers at positions where the reflecting electrodes are not disposed, so that the liquid crystal layer thickness is maintained constant at a height of the column. Either of these solutions can be applied to the display device of the invention.

However, in case of applying method of dispersing spacers to the display device of the invention, the light emitting devices are prone to be damaged by the spacers unless manufacturing conditions for the process of combining and fixing two substrates are optimum. The reason is that generally the spacer is made of glass having a substantially high hardness, which causes a load to be imposed on the light emitting device through the protection layer. Depending on a material for constituting the light emitting device its load resistance may be insufficient, in which case the light emitting device may be destroyed even merely by a finger press on the display panel during an operation. Therefore, an embodiment wherein a column that eliminates such risk is adopted shall be described hereunder.

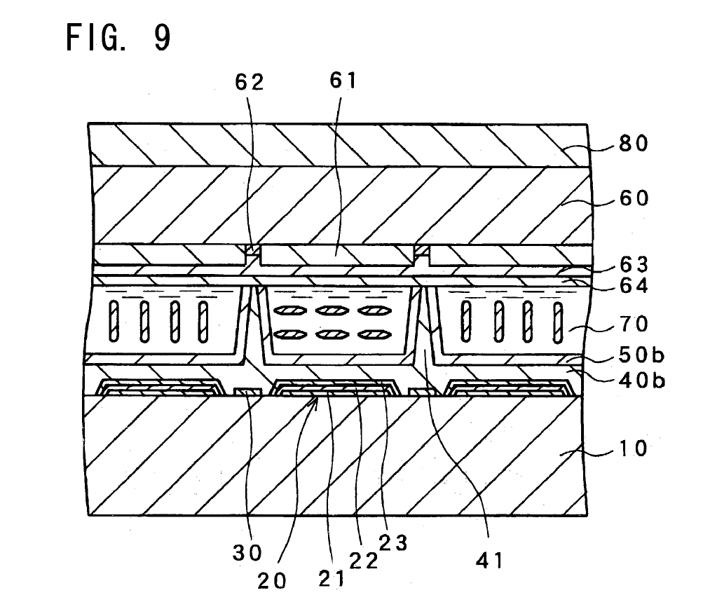

FIG. 9 is a schematic cross-sectional drawing of a display device according to the second embodiment of the invention, in particular a pixel portion thereof. Referring to FIG. 9, a factor identical to that of FIG. 1 is denoted by an identical reference numeral, and detailed description thereof shall be omitted. In this embodiment, a shape of a protection layer 40b formed over the light emitting device 20 shall be focused on. Specifically, a projection 41 is provided at a position corresponding to the wiring 30 in the protection layer 40b, and an end portion of the projection 41 is in contact with the alignment layer 64 provided on the transparent substrate 60.

In FIG. 9, the projection 41 serves as a spacer for maintaining a thickness of the liquid crystal 70 constant all over its displaying area. Also, it is known that in the proximity of the spacer the alignment of the liquid crystal molecules becomes disorderly to cause a light leakage, however such irregular light is absorbed by the black matrix 62 and cannot leak outside. Consequently, black can be clearly displayed in the reflection mode.

Such projection 41 can be formed by lithography and etching after forming a thick protection layer 40b. In this case, the protection layer 41b and the projection 41 are formed of an identical material. Otherwise, a different material may be layered in a sufficient thickness over the protection layer 40 formed in an originally specified thickness, so that lithography and etching may be performed to form the projection 41. Further, a projection may be formed on the transparent substrate 60 instead of the substrate 10, so that a constitution shown in FIG. 9 may be achieved by combining the substrates and injecting the liquid crystal. The latter two manufacturing methods have the disadvantage of an increase of manufacturing steps since the protection layer and the projection are formed of different materials. On the other hand, the constitution wherein the projection is provided on the transparent substrate 60 has the advantage of easier positioning of the projection with the black matrix.

Third Embodiment

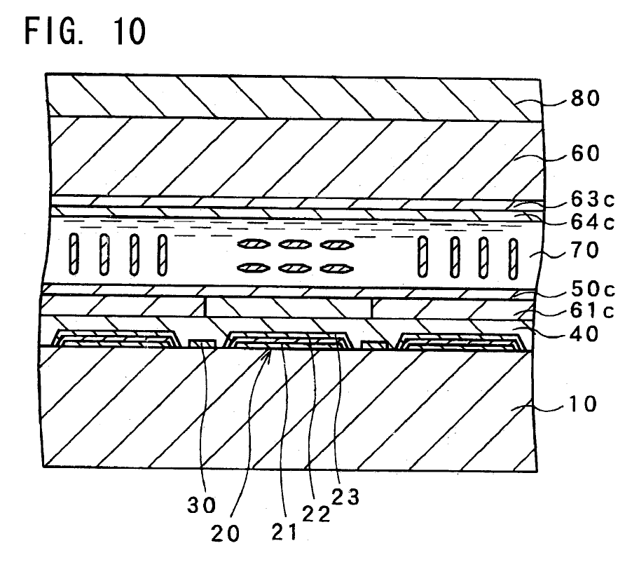

FIG. 10 is a schematic cross-sectional drawing showing a display device according to the third embodiment of the invention. Referring to FIG. 10, a factor identical to that of FIG. 1 is denoted by an identical reference numeral, and detailed description thereof shall be omitted. In the foregoing first and second embodiments the color filter is disposed on the transparent substrate, while the color filter 61c may be provided above the light emitting device 20 with the protection layer 40 therebetween, on the substrate 10 on which the light emitting device 20 is provided. In other words, the color filter 61c is formed directly over the protection layer 40. By such constitution, an identical effect as that of the first embodiment can be achieved.

Consequently, it is to be understood that according to the invention a display device performs as a reflection type liquid crystal display device in a light place and as a self-emission type display device in a dark place, since each pixel is provided with a light emitting device having a function of reflecting light, a liquid crystal layer and a color filter. In other words, in the reflection mode the cathode of the light emitting device serves as a reflecting plate of ambient light, and ON/OFF of the ambient light reflection is switched based on a combination of alignment control of the liquid crystal and a circular polarizing plate. Also, in the self-emission mode ON/OFF of light emission is switched by a current control circuit of the pixel, and reflection of ambient light is shielded by the circular polarizing plate. Therefore by appropriately selecting these display modes according to an ambient light intensity, a clear image can be displayed both in a light place and in a dark place.

Further, the constitution shown in FIG. 9 according to the second embodiment has the advantage of a higher resistance against an external force that may be imposed during a manufacturing process or practical use of the display device, in addition to the aforementioned advantages.

What is claimed is:

1. A display device comprising a first substrate on which a plurality of light emitting devices including a reflecting electrode is disposed; a second substrate made of a transparent material provided with a color filter and a transparent electrode; a liquid crystal layer placed between said first substrate and said second substrate disposed in such a manner that a face of said light emitting devices and a face of said transparent electrode confront each other; and a driving circuit for controlling a voltage to be applied to said liquid crystal layer, and selecting either a reflection display mode of displaying an image by reflecting ambient light with said reflecting electrode of said light emitting device or a self-emission display mode of displaying an image by light emission of said light emitting device.

2. A display device comprising a first substrate on which a plurality of light emitting devices including a reflecting electrode is disposed and a color filter is provided over them; a second substrate made of a transparent material provided with a transparent electrode; a liquid crystal layer provided between said first substrate and said second substrate disposed in such a manner that a face of said color filter and a face of said transparent electrode confront each other; and a driving circuit for controlling a voltage to be applied to said liquid crystal layer, and selecting either a reflection display mode of displaying an image by reflecting ambient light with said reflecting electrode of said light emitting device or a self-emission display mode of displaying an image by light emission of said light emitting device.

3. The display device as set forth in claim 1, wherein said light emitting device further comprise a light emitting material formed on said reflecting electrode and a transparent electrode formed on said light emitting material.

4. The display device as set forth in claim 2, wherein said light emitting device further comprise a light emitting material formed on said reflecting electrode and a transparent electrode formed on said light emitting material.

5. The display device as set forth in claim 3, wherein said driving circuit further controls optical characteristic of said liquid crystal through control of a voltage applied between said transparent electrode of said light emitting device and said transparent electrode of said second substrate, and controls light emission by said light emitting device through control of a voltage applied between said transparent electrode of said light emitting device and said reflecting electrode.

6. The display device as set forth in claim 4, wherein said driving circuit further controls optical characteristic of said liquid crystal through control of a voltage applied between said transparent electrode of said light emitting device and said transparent electrode of said second substrate, and controls light emission by said light emitting device through control of a voltage applied between said transparent electrode of said light emitting device and said reflecting electrode.

7. The display device as set forth in claim 5, wherein each of said light emitting devices and said color filter corresponding to each light emitting device constitute a pixel, and said driving circuit comprises a switching transistor for selecting each of such pixels, light emission amount control circuit for controlling a current amount of said light emitting device and a switching control circuit for switching to either said reflection display mode or said self-emission display mode.

8. The display device as set forth in claim 6, wherein each of said light emitting devices and said color filter corresponding to each light emitting device constitute a pixel, and said driving circuit comprises a switching transistor for selecting each of such pixels, light emission amount control circuit for controlling a current amount of said light emitting device and a switching control circuit for switching to either said reflection display mode or said self-emission display mode.

9. The display device as set forth in claim 7, wherein said switching control circuit electrically connects said reflecting electrode of said light emitting device with said transparent electrode of light emitting device as well as said switching transistor with said reflecting electrode of said light emitting device, in said reflection display mode.

10. The display device as set forth in claim 8, wherein said switching control circuit electrically connects said reflecting electrode of said light emitting device with said transparent electrode of light emitting device as well as said switching transistor with said reflecting electrode of said light emitting device, in said reflection display mode.

11. The display device as set forth in claim 7, wherein said switching control circuit connects said light emitting device with said light emission amount control circuit as well as said switching transistor with said light emission amount control circuit, in said self-emission display mode.

12. The display device as set forth in claim 8, wherein said switching control circuit connects said light emitting device with said light emission amount control circuit as well as said switching transistor with said light emission amount control circuit, in said self-emission display mode.

13. The display device as set forth in claim 9, wherein said switching control circuit connects said light emitting device with said light emission amount control circuit as well as said switching transistor with said light emission amount control circuit, in said self-emission display mode.

14. The display device as set forth in claim 10, wherein said switching control circuit connects said light emitting device with said light emission amount control circuit as well as said switching transistor with said light emission amount control circuit, in said self-emission display mode.

15. The display device as set forth in claim 1, further comprising a circular polarizing plate on a surface of said second substrate on a face not confronting said liquid crystal layer, so that said driving circuit adjusts a reflection factor of ambient light by switching a polarization status of light passing through said liquid crystal layer, in said reflection display mode.

16. The display device as set forth in claim 2, further comprising a circular polarizing plate on a surface of said second substrate on a face not confronting said liquid crystal layer, so that said driving circuit adjusts a reflection factor of ambient light by switching a polarization status of light passing through said liquid crystal layer, in said reflection display mode.

17. The display device as set forth in claim 1, further comprising a circular polarizing plate on a surface of said second substrate on a face not confronting said liquid crystal layer, so that said driving circuit maintains a constant polarization status of light passing through said liquid crystal layer, in said self-emission display mode.

18. The display device as set forth in claim 2, further comprising a circular polarizing plate on a surface of said second substrate on a face not confronting said liquid crystal layer, so that said driving circuit maintains a constant polarization status of light passing through said liquid crystal layer, in said self-emission display mode.

19. The display device as set forth in claim 1, wherein said first substrate further comprises a protection layer covering said light emitting device and a first alignment layer formed on said protection layer, and said second substrate further comprises a second alignment layer formed on said transparent electrode.

20. The display device as set forth in claim 2, wherein said first substrate further comprises a protection layer formed between said color filter and said light emitting device so as to cover said light emitting device and a first alignment layer formed on said color filter, and said second substrate further comprises a second alignment layer formed on said transparent electrode.

21. The display device as set forth in claim 19, wherein said protection layer comprises a projection or a strut that reaches said second substrate, between said first substrate and said second substrate and in a region where said light emitting devices are not located.

22. Driving method of a display device comprising a first substrate on which a plurality of light emitting devices including a reflecting electrode is disposed; a second substrate made of a transparent material provided with a color filter and a transparent electrode; a liquid crystal layer provided between said first substrate and said second substrate disposed in such a manner that a face of said light emitting devices and a face of said transparent electrode confront each other; comprising the steps of controlling a voltage to be applied to said liquid crystal layer, and selecting either a reflection display mode of displaying an image by reflecting ambient light with said reflecting electrode of said light emitting device or a self-emission display mode of displaying an image by light emission of said light emitting device.

23. Driving method of a display device comprising a first substrate on which a plurality of light emitting devices including a reflecting electrode is disposed and a color filter is provided over them; a second substrate made of a transparent material provided with a transparent electrode; a liquid crystal layer provided between said first substrate and said second substrate disposed in such a manner that a face of said color filter and a face of said transparent electrode confront each other; comprising the steps of controlling a voltage to be applied to said liquid crystal layer, and selecting either a reflection display mode of displaying an image by reflecting ambient light with said reflecting electrode of said light emitting device or a self-emission display mode of displaying an image by light emission of said light emitting device.

24. Driving method of a display device as set forth in claim 22, wherein said reflecting electrode and said transparent electrode of said light emitting device formed with said light emitting material disposed therebetween are electrically connected in said reflection display mode.

25. Driving method of a display device as set forth in claim 23, wherein said reflecting electrode and said transparent electrode of said light emitting device formed with said light emitting material disposed therebetween are electrically connected in said reflection display mode.

26. Driving method of a display device as set forth in claim 22, wherein a light emission amount control circuit for controlling a light emission amount of said light emitting device is connected with said light emitting device, in said self-emission display mode.

27. Driving method of a display device as set forth in claim 23, wherein a light emission amount control circuit for controlling a light emission amount of said light emitting device is connected with said light emitting device, in said self-emission display mode.
